(19) United States
(12) Patent Application Publication
(10) Pub. No.: US 2026/0355875 A1
(43) Pub. Date: Nov. 12, 2026

(54) JOINING MODULE COMPRISING A TORQUE SUPPORT DEVICE AND A PROCESS FOR MANUFACTURING SUCH A JOINING MODULE WITH A TORQUE SUPPORT DEVICE

(71) Applicant: Kistler Holding AG, Winterthur (CH)

(72) Inventors: Jochen SCHNEIDER, Schorndorf (DE); Chang LIU, Donzdorf (DE)

(21) Appl. No.: 19/669,179

(22) Filed: May 6, 2026

(30) Foreign Application Priority Data
May 9, 2025 (EP) 25175465.1

(51) Int. Cl. B23P 19/04

(52) U.S. Cl. CPC B23P 19/04

(57) ABSTRACT

A joining module includes a torque support device, a drive unit, a threaded drive, a plunger, and a housing. The threaded drive converts a rotational movement of the drive unit into a linear movement. The plunger is mounted on the threaded drive and is movable with the linear motion along a longitudinal axis. The torque support device includes a guide groove and a guide element. The guide groove is mounted in the housing, and the guide element is connected to the plunger in a non-rotatable manner, and so as to protrude into the guide groove. The guide groove includes a groove body and a groove insert so that the guide element is in direct mechanical contact with the groove insert to prevent rotation of the plunger about the longitudinal axis.

### TECHNICAL FIELD

The invention relates to a joining module comprising a torque support device and a process for manufacturing such a joining module with a torque support device.

### BACKGROUND OF THE INVENTION

Joining modules are used in industrial manufacturing for a wide variety of assembly and joining processes such as embossing, punching, riveting, clinching, and the like. A joining module such as referenced in commonly owned US Patent No. 11,454,948, which is hereby incorporated herein in its entirety by this reference for all purposes, is used to move a tool required for an assembly and joining process into a workpiece and to apply a force required for the assembly and joining process. Joining modules are available as electromechanical, pneumatic, or hydraulic modules. The applicant manufactures and distributes electromechanical joining modules as described in leaflet 960-283e-09.24.pdf, available at wwww.kistler.com.

Such an electromechanical joining module comprises a drive, a threaded drive, a plunger, and a force transducer. The drive is in operative connection with the threaded drive, and a rotational movement of the drive is converted by said threaded drive into a linear movement. The plunger and the force transducer are mounted on the threaded drive and are moved along a longitudinal axis by the linear motion. The plunger carries the tool or workpiece. The required force is applied via the plunger. The force transducer measures the applied force and generates measurement data for the measured force.

For high-precision industrial manufacturing, a joining module comprises a stroke length of several hundred millimeters, a high motion speed of up to 800 mm/s, a high cycle rate of over 10 strokes/min, and a high repeatability of 0.01 mm. The joining module is designed for a long service life of over 10⁶ strokes. During the linear motion of the threaded drive and plunger, rotation about the longitudinal axis must be avoided. This is because such rotation leads to incorrect radial alignment of the tool and workpiece, depending on the assembly and joining process. Such rotation also leads to inaccurate linear alignment of the tool and workpiece, since the linear alignment is derived from the angular position of the drive. To this end, the joining module comprises a torque support device.

### OBJECTS AND SUMMARY OF THE INVENTION

A primary object of the present invention is to provide a joining module comprising a torque support device, which torque support device prevents rotation about the longitudinal axis during the linear movement of the threaded drive and plunger, and which torque support device is largely maintenance-free and thus low-wear and cost-effective. A second object of the invention is to disclose a cost-effective method for manufacturing such a joining module with a torque support device.

These objects are solved by the features described below.

The invention relates to a joining module comprising a torque support device; which joining module comprises a drive unit, a threaded drive, a plunger, and a housing; which threaded drive converts the rotational motion of the drive unit into a linear motion; which plunger is mounted on the threaded drive and is movable along a longitudinal axis by the linear motion; which torque support device comprises at least one guide groove and at least one guide element; which guide groove is mounted in the housing, which guide element is connected to the plunger in a non-rotatable manner, and which guide element protrudes into the guide groove in certain areas; wherein said guide groove comprises a groove body and at least one groove insert, and wherein the guide element protruding into the guide groove is in direct mechanical contact with the groove insert, which direct mechanical contact prevents rotation of the plunger about the longitudinal axis.

The invention also relates to a process for manufacturing a joining module with a torque support device (16); which joining module comprises a drive unit, a threaded drive, a plunger, and a housing; which threaded drive converts a rotational movement of the drive unit into a linear movement; which plunger is mounted on the threaded drive and is movable with the linear movement along a longitudinal axis; which torque support device comprises at least one guide groove and at least one guide element; which guide groove is machined to a tolerance of not more than 0.1mm before being mounted in the housing, which guide element is connected to the plunger in a non-rotatable manner, and which guide element protrudes into the guide groove in certain areas; wherein at least one groove insert is provided; and wherein the groove insert is inserted into the guide groove such that the guide element protruding into the guide groove is in direct mechanical contact with the groove insert, which direct mechanical contact prevents rotation of the plunger about the longitudinal axis.

During the linear movement of the plunger, the guide element connected to the plunger is in direct mechanical contact with a groove insert in the guide groove. Said groove insert minimizes wear of the guide groove caused by the linear movement of the guide element. And since the guide groove is mounted in the housing, the direct mechanical contact prevents rotation of the guide element and thus of the plunger about the longitudinal axis. As a result, the torque support device exhibits low wear and is largely maintenance-free and cost-effective to maintain.

The groove insert according to the invention can be easily and quickly inserted into the guide groove. This renders the production of the torque support device of the joining module cost-effective.

Advantageous embodiments of the invention are described below.

### BRIEF DESCRIPTION OF THE DRAWINGS

In the following, the invention is explained in more detail with reference to the figures in which:

FIG. 1 shows a cross-section cut along a longitudinal axis through a portion of a joining module 1 comprising a torque support device 16;

FIG. 2 shows a first enlarged detail B1 of the cross-section of the joining module 1 comprising said torque support device 16 as shown in FIG. 1;

FIG. 3 shows a cross-sectional view along a section line A - A of a portion of the joining module 1 comprising said torque support device 16 according to FIG. 2; and

FIG. 4 shows a second enlarged detail B2 of the section line A - A of the joining module 1 comprising said torque support device 16 according to FIG. 3.

Like reference numerals denote identical objects in the figures.

### DETAILED DESCRIPTION OF EXEMPLARY EMBODIMENTS OF THE INVENTION

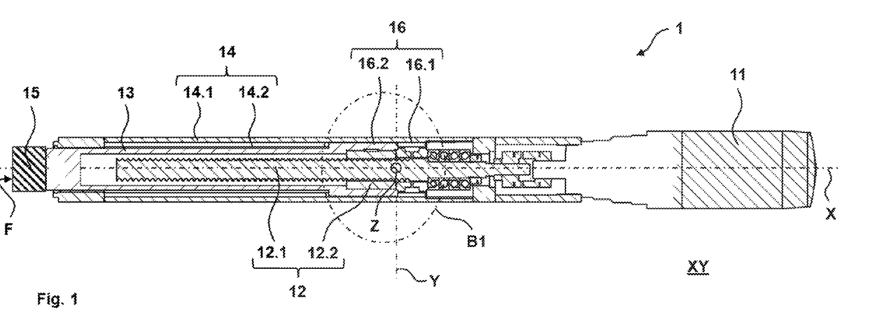

FIG. 1 shows a cross-section of a portion of a joining module 1. Joining module 1 is depicted in a coordinate system with three axes: X, Y, and Z. The three axes X, Y, Z are perpendicular to each other. The three axes X, Y, and Z comprise a longitudinal axis X along which the joining module 1 elongates, a transverse axis Y, and a vertical axis Z. The cross-section is shown in a transverse plane XY defined by the longitudinal axis X and the transverse axis Y.

The joining module 1 comprises a drive unit 11, a threaded drive 12, a plunger 13, and a housing 14.

The drive unit 11 has the function to move the plunger 13 along the longitudinal axis X relative to the housing 14 and to apply a force F via said plunger 13. In an industrial manufacturing context, force F is used to perform an assembly and joining process such as embossing, punching, riveting, clinching, and the like. Advantageously, said drive unit 11 comprises a motor, a brake, and a control unit. A joining module 1 with an electric drive unit 11 is characterized by high energy efficiency.

The drive unit 11 is connected to the threaded drive 12 in an operative manner. The threaded drive 12 has the function to convert a rotational movement of the drive unit 11 into a linear movement. To this end, the threaded drive 12 comprises a spindle 12.1 and a spindle nut 12.2. The spindle 12.1 and the spindle nut 12.2 are made of a mechanically durable material such as steel, stainless steel, cast iron, and the like. The spindle 12.1 and the spindle nut 12.2 comprise threads that match each other. The spindle nut 12.2 is mounted rotatably on the spindle 12.1. The spindle 12.1 is connected to the drive unit 11 in a non-rotatable manner. The spindle 12.1 is connected to the drive unit 11 by suitable means such as screws, press fit, and the like. The rotational movement of the drive unit 11 accordingly rotates the spindle 12.1 with respect to the spindle nut 12.2 and causes a linear movement of the spindle nut 12.2. The linear motion of the spindle nut 12.2 occurs along the longitudinal axis X. The stroke length of the joining module 1 can be several hundred millimeters.

The plunger 13 has the function to carry a tool or workpiece required during the assembly and joining process. The tool or workpiece is not shown in the figures. Said tool or workpiece is connected to the plunger 13. Said tool or workpiece is connected to the plunger 13 by suitable means such as screws, clamping, and the like.

The plunger 13 is made of a mechanically durable material such as steel, stainless steel, cast iron, and the like. Said plunger 13 defines a hollow internal space that elongates about the longitudinal axis and configured to accommodate receiving the threaded drive 12 and desirably is attached to the threaded drive 12 near the end of the plunger 13 disposed in the vicinity of the drive unit 11. The plunger 13 is arranged on a side of the spindle nut 12.2 facing away from the spindle 12.1. The plunger 13 is connected to the spindle nut 12.2. The plunger 13 is connected to the spindle nut 12.2 by suitable means such as screws, press fit, adhesive, and the like so as to ensure that the plunger 13 and the spindle nut 12.2 are moved together in a linear motion along the longitudinal axis X. Due to the linear motion, the tool or workpiece carried by the plunger 13 can be moved over a defined stroke length of the joining module 1, and the plunger 13 applies the force F required for the assembly and joining process.

The joining module 1 comprises a force transducer 15. The force transducer 15 has the function to measure the force F applied via the plunger 13. The force transducer 15 is arranged at an end of the plunger 13 facing away from the drive unit 11. The force transducer 15 is connected to the plunger 13. The force transducer 15 is connected to the plunger 13 by suitable means such as screws, press fit, adhesive, and the like. The force transducer 15 may be a strain gauge or a piezoelectric sensor. The force transducer 15 is not limited to measure a force F. It can also be configured to measure a moment applied via the plunger 13, such as a bending moment, a torque, and the like. It can be configured to measure the force F over several orders of magnitude.

The housing 14 has the function to protect the threaded drive 12 and the force transducer 15 from harmful environmental influences such as contaminants (dust, moisture, and the like). Such contaminants can impair the functionality of the joining module 1. The housing 14 comprises a housing body 14.1 made of a mechanically durable material such as aluminum, steel, stainless steel, and the like. Preferably, the housing body 14.1 is an extruded profile made of aluminum, aluminum alloys, and the like. The housing 14 is hollow-cylindrical in shape and defines an internal cavity 14.2. The threaded drive 12 and the force transducer 15 are located within the cavity 14.2. The housing 15 radially encloses the threaded drive 12 and the force transducer 15. The housing 14 elongates along the longitudinal axis between a first opening and a second opening at opposite ends of the housing 14. The drive unit 11 protrudes into the housing 14 through the first opening. The end of the plunger 13 facing away from the drive unit 11 protrudes from the housing 14 through the second opening. The first opening and the second opening are sealed against the ingress of contaminants into the cavity 14.2 by conventional suitable means such as sealing rings, and the like.

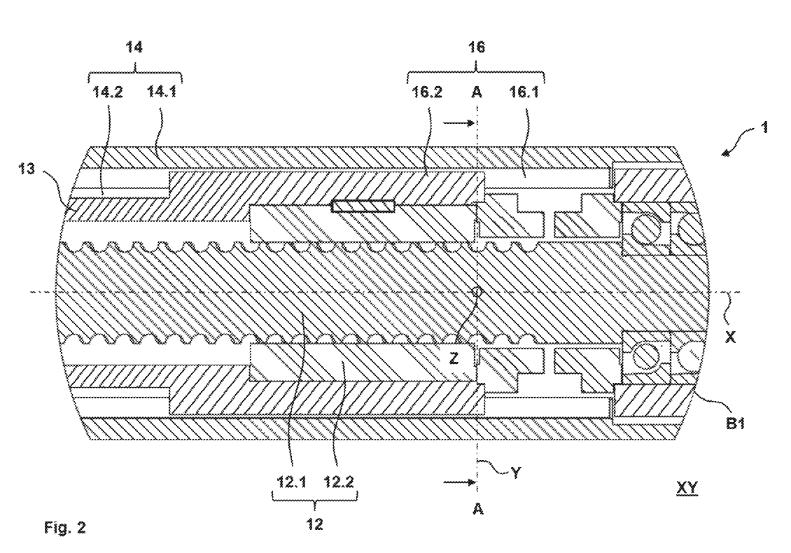

The joining module 1 comprises a torque support device 16. The torque support device 16 has the function to prevent rotation of the plunger 13 about the longitudinal axis X during the linear movement of the spindle nut 12.1 and the plunger 13 along the longitudinal axis X. FIGS. 2 through 4 show details of the torque support device 16.

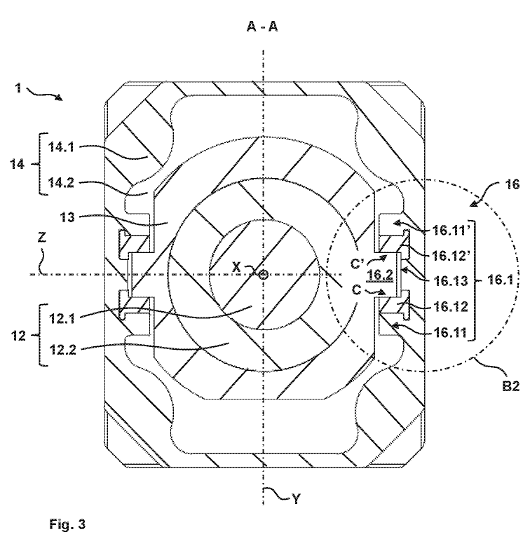

The torque support device 16 is defined so as to include at least one guide element 16.2 and at least one guide groove 16.1. In the illustration shown in FIG. 3 looking along the longitudinal axis at a cross-sectional view in a Y - Z plane, the torque support device 16 comprises two guide elements 16.2 and two guide grooves 16.1. Relative to the transverse axis Y, the two guide elements 16.2 and the two guide grooves 16.1 comprise a left and a right guide element 16.2 as well as a left and a right guide groove 16.1. The two guide elements 16.2 and the two guide grooves 16.1 are arranged symmetrically with respect to the transverse axis Y. The two guide elements 16.2 and the two guide grooves 16.1 lie on the vertical axis Z. The two guide elements 16.2 and the two guide grooves 16.1 are spaced apart from one another at an angle of 180° around the longitudinal axis X and accordingly mirror each other. For reasons of clarity, only the right guide element 16.2 and the right guide groove 16.1 are labeled with reference numerals in FIG. 3, and the description of the right guide groove 16.1 and the right guide element 16.2 apply to the left guide groove 16.1 and the left guide element 16.2 that are not labelled in FIG. 3 .

The guide groove 16.1 is placed in the housing 14. Preferably, the guide groove 16.1 is placed in the cavity 14.2 of the housing 14 during the extrusion of the housing 14. Preferably, the guide groove 16.1 extends over the entire stroke length of the joining module 1 parallel to the longitudinal axis X.

The guide groove 16.1 is partially defined by a groove body 16.11, 16.11'. Preferably, the housing body 14.1 and the groove body 16.11, 16.11' are integrally formed. Preferably, the housing body 14.1 and the groove body 16.11, 16.11' are manufactured as an extruded profile.

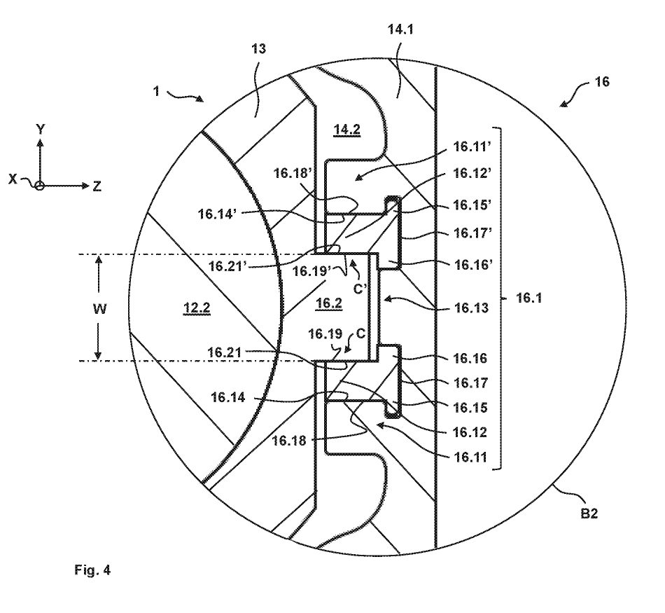

The groove body 16.11, 16.11' encloses a groove space 16.13 in certain areas regions of the guide groove 16.1. Preferably, as schematically shown in FIG. 3, the groove body 16.11, 16.11' is U-shaped and defined by a first leg 16.11 and a second leg 16.11' spaced apart from the first leg 16.11 along the transverse axis Y. The two legs 16.11, 16.11' extend into the cavity 14.2. As shown in FIGS. 3 and 4, said groove space 16.13 elongates in a direction that is parallel to the transverse axis Y between the two legs 16.11, 16.11' defining the guide groove 16.1.

The torque support device 16 includes at least one groove insert 16.12, 16.12' disposed within the guide groove 16.1. Preferably, each groove insert 16.12, 16.1' is made of a material with a low coefficient of friction, which material is one of the following: polyoxymethylene (POM), polyethylene terephthalate (PET), polyether ether ketone (PEEK), polytetrafluoroethylene (PTFE). With knowledge of the present invention, a person skilled in the art may also use other known materials with a low coefficient of friction.

Preferably, each groove insert 16.12, 16.12' extends over the entire stroke length of the joining module 1 parallel to the longitudinal axis X. As schematically shown in FIG. 3’s cross-sectional view across an YZ plane, there’s another pair of groove inserts, which are unnumbered but identical to the pair of groove inserts numbered 16.12, 16.12’, on the left side of FIG. 3. Accordingly, the presently preferred embodiment includes four separate groove inserts. However, for the sake of brevity and avoidance of duplicative text, only the pair of groove inserts 16.12 and 16.12’ and the guide groove 16.1 on the right side of FIG. 3 will be discussed herein.

The groove insert 16.12, 16.12' is connected to the groove body 16.11, 16.11'. According to FIGS. 3 and 4, the guide groove 16.1 surrounds two groove inserts 16.12, 16.12'. The groove inserts 16.12, 16.12' comprise a first groove insert 16.12 and a second groove insert 16.12'. The first groove insert 16.12 is engaged with the first leg 16.11, and the second groove insert 16.12' is engaged with the second leg 16.11'.

The groove inserts 16.12, 16.12' are connected to the groove bodies 16.11, 16.11' via at least one of the following types of connection: positive fit, material bond, force fit, positive fit and material bond, positive and force fit, material bond and force fit, positive fit, material bond, and force fit.

Preferably, the groove insert 16.12, 16.12' is connected to the groove body 16.11, 16.11' via a positive fit. As schematically shown in FIG. 3, the protrusion of the guide element 16.2 along the vertical axis Z into the groove space 16.13 between the two legs 16.11, 16.11’ of the groove body defined by the internally facing features of the housing body 14.1, combines with the configuration of each groove insert 16.12, 16.12’ to constrain movements of each groove insert 16.12, 16.12’ to only movements in a direction parallel to the longitudinal axis X. As schematically shown in FIG. 4, each respective groove insert 16.12, 16.12' is defined by at least one positive-fit element 16.15, 16.15', 16.16, 16.16', and said groove body defined by and between the spaced apart legs 16.11, 16.11' is defined by at least one complementary positive-fit feature 16.17, 16.17’ defined in the internally facing surface of the housing body 14.1. As shown in FIG. 4, the side of groove insert 16.12 facing the internal surface of the housing body 14.1 is defined by a first positive-fit element 16.15 projecting along the transverse axis Y and a second positive-fit element 16.16 projecting in the opposite direction along the transverse axis Y. The complementary positive-fit feature 16.17 defined in the internally facing surface of the housing body 14.1 receives and engages the first positive-fit element 16.15 and second positive-fit element 16.16 of the groove insert 16.12. This same positive-fit configuration likewise exists on the left side of the cross-sectional view shown in FIG. 3. Turning now to the groove insert 16.12’ depicted in FIG. 4, the side of groove insert 16.12’ facing the internal surface of the housing body 14.1 is defined by a first positive-fit element 16.15’ projecting along the transverse axis Y and a second positive-fit element 16.16’ projecting in the opposite direction along the transverse axis Y. The complementary positive-fit feature 16.17’ defined in the internally facing surface of the housing body 14.1 receives and engages the first positive-fit element 16.15’ and second positive-fit element 16.16’ of the groove insert 16.12’. This same positive-fit configuration likewise exists on the left side of the cross-sectional view shown in FIG. 3.

According to FIGS. 3 and 4, as noted above, each groove insert 16.12, 16.12' is formed as a T-shaped strip. The T-shaped strip is defined by two arms extending parallel to the transverse axis Y and outwardly away from each other from one end of a base, which extends parallel to the vertical axis Z and towards the internal surface of the housing body 14.1. A first arm 16.15, 16.15’ of the T-strip forming each respective groove insert 16.12, 16.12’ extends parallel to the transverse axis Y towards the groove body 16.11, 16.11', while the second arm 16.16, 16.16’ extends parallel to the transverse axis Y towards the groove space 16.13. The first positive-fit element 16.15, 16.15' is formed on the first arm. The second positive-fit element 16.16, 16.16' is formed on the second arm.

The complementary positive-fit feature 16.17, 16.17’ is configured to receive the positive-fit elements 16.15, 16.15', 16.16, 16.16' in a positive-fit manner. According to FIGS. 3 and 4, the complementary positive-fit feature 16.17, 16.17’ is formed in a pan-like shape within the groove body 16.11, 16.11'. The pan extends parallel to the transverse axis Y. The dimensions of the pan in the groove body 16.11, 16.11' are matched to the dimensions of the arms of the T-shaped groove insert 16.12, 16.12'. The first complementary positive-fit element 16.17 in the first leg 16.11 is configured to receive the first positive-fit element 16.15 and the first second positive-fit element 16.16 of the first groove insert 16.12. The second complementary positive-fit element 16.17' in the second leg 16.11' is configured to receive the first positive-fit element 16.15' and the second positive-fit element 16.16' of the second groove insert 16.12'.

With knowledge of the present invention, a person skilled in the art may also design the positive-fit elements in a different manner and, for example, design the complementary positive-fit element in a T-shape and the positive-fit element in a pan-shape.

Preferably, the groove insert 16.12, 16.12' is inserted into the groove space 16.13 and, by sliding the positive-fit element 16.15, 16.15', 16.16, 16.16' in the direction parallel to the longitudinal axis X into the complementary positive-fit feature 16.17, 16.17’ to form a positive fit with the groove body 16.11, 16.11'.

The base of each groove insert 16.12, 16.12', which is formed as a T-shaped strip shown in cross-section in FIGS. 3 and 4, defines two surfaces 16.18, 16.18', 16.19, 16.19'. The two surfaces 16.18, 16.18', 16.19, 16.19' of each groove insert 16.12, 16.12’ define a first surface 16.18, 16.18' and a second surface 16.19, 16.19'. The first surface 16.18, 16.18' is oriented to lie in a plane disposed parallel to the plane defined by the longitudinal axis X and the vertical axis Z and elongates towards the guide element 16.2. The second surface 16.19, 16.19' likewise is oriented to lie in a plane disposed parallel to the plane defined by the longitudinal axis X and the vertical axis Z and elongates towards the guide element 16.2. The two surfaces 16.18, 16.18', 16.19, 16.19' thus extend in a plane parallel to the longitudinal axis X and parallel to the vertical axis Z. For reasons of clarity, the two surfaces 16.18, 16.18', 16.19, 16.19' are shown with reference numerals only in the enlarged section B2 according to FIG. 4.

Each respective groove insert 16.12, 16.12', which is connected in a positive fit to the respective groove body 16.11, 16.11', covers the respective groove body 16.11, 16.11' in certain areas. To this end, said groove body 16.11, 16.11' defines at least one supporting surface 16.14, 16.14'. The supporting surface 16.14, 16.14' is aligned parallel to the vertical axis Z towards the groove insert 16.12, 16.12'. The supporting surface 16.14, 16.14' extends in a plane parallel to the longitudinal axis X and parallel to the vertical axis Z. Thus, there is a first supporting surface 16.14 defined by the first groove body 16.11 and a second supporting surface 16.14' defined by the second groove body 16.11'.

Preferably, a respective first surface 16.18, 16.18' of the groove insert 16.12, 16.12' covers the respective supporting surface 16.14, 16.14' of the groove body 16.11, 16.11' in certain areas. The first surface 16.18 of the first groove insert 16.12 covers the first supporting surface 16.14 of the first groove body 16.11. The first surface 16.18' of the second groove insert 16.12' covers the second supporting surface 16.14' of the second groove body 16.11'. For reasons of clarity, the supporting surface 16.14, 16.14' is shown with reference numerals only in the enlarged detail B2 according to FIG. 4.

A respective one of two second surfaces 16.19, 16.19' of each respective groove insert 16.12, 16.12' is arranged along the transverse axis Y at a distance from one another, which is hereinafter also referred to as the width W of the groove space 16.3. The width W of the groove space 16.3 is shown in FIG. 4.

The guide element 16.2 is made of a mechanically durable material such as aluminum, steel, stainless steel, and the like.

The guide element 16.2 is attached to the plunger 13. The guide element 16.2 is connected to the plunger 13 in a non-rotatable manner. The guide element 16.2 is connected to the plunger 13 by suitable means such as screws, press fit, adhesive, and the like. However, the guide element 16.2 desirably is an integrally formed feature of the plunder 13 during a process of extruding the plunger 13 or machining the outer surface of the plunger 13.

As shown in FIGS. 3 and 4, said guide element 16.2 is bar-shaped. The guide element 16.2 protrudes along the vertical axis Z from an outer boundary surface of the plunger 13 and configured to fit into the guide groove 16.1 in certain areas of the guide groove 16.1. According to FIGS. 3 and 4, the guide element 16.2 protrudes into the groove space 16.13 of the guide groove 16.1. The second surface 16.19, 16.19' of the groove insert 16.12, 16.12' is oriented parallel to the vertical axis Z towards the guide element 16.2 protruding into the groove space 16.13.

The guide element 16.2 is in operative connection with the guide groove 16.1. The operative connection is established via a direct mechanical contact C, C'. As shown in FIGS. 3 and 4, the direct mechanical contact C, C' extends in a plane parallel to the longitudinal axis X and parallel to the vertical axis Z. The direct mechanical contact C, C' comprises a first direct mechanical contact C and a second direct mechanical contact C'. Via the first direct mechanical contact C, the guide element 16.2 is in operative connection with the first groove insert 16.12. Via the second direct mechanical contact C', the guide element 16.2 is in operative connection to the second groove insert 16.12'.

The guide element 16.2 comprises at least one contact surface 16.21, 16.21'. The contact surface 16.21, 16.21' is aligned parallel to the transverse axis Y towards the groove insert 16.12, 16.12'. The contact surface 16.21, 16.21' extends in a plane parallel to the longitudinal axis X and parallel to the vertical axis Z. The contact surface 16.21, 16.21' comprises a first contact surface 16.21 and a second contact surface 16.21'. The first contact surface 16.21 forms the first direct mechanical contact C of the guide element 16.2 with the second surface 16.19 of the first groove insert 16.12. The second contact surface 16.21' forms the second direct mechanical contact C' of the guide element 16.2 with the second surface 6.19' of the second groove insert 16.12.

Preferably, the contact surfaces 16.21, 16.21' of the guide element 16.2 are made of a low-wear material, which material is one of the following: anodized aluminum (electrolytic oxidation of aluminum), hard anodized aluminum. With knowledge of the present invention, a person skilled in the art may also use other known low-wear materials.

Rotation of the plunger 13 about the longitudinal axis X results in a torque that acts parallel to the transverse axis Y on the direct mechanical contact C, C' between the guide element 16.2 and the groove insert 16.12, 16.12'. The torque acts from the guide element 16.2 via the groove insert 16.12, 16.12' onto the groove body 16.11, 16.11'. The groove body 16.11, 16.11', in turn, for which it is advantageous to be integrally formed with the housing body 14.1, rests on the housing body 14.1 and is held at rest by a counter-torque. However, in this manner said guide element 16.2 and said groove insert 16.12, 16.12', which are in direct mechanical contact C, C' with each another, are also held at rest. Thus, the guide element 16.2, which is in direct mechanical contact C, C' with the guide groove 16.1, prevents rotation of the guide element 16.2 and thus of the plunger 13 about the longitudinal axis X.

At the same time, the low coefficient of friction of the material of the groove insert 16.12, 16.12' enables linear movement of the guide element 16.2 and thus of the plunger 13 along the longitudinal axis X over the entire stroke length of the joining module 1.

The guide element 16.2 is inserted into the groove space 16.13. The insertion of said guide element 16.2 into the groove space 16.13 is carried out by sliding it in parallel to the longitudinal axis X, by inserting it along the vertical axis Z, and the like.

The guide element 16.2 and the guide groove 16.1 are aligned with each other along the longitudinal axis X over the entire stroke length of the joining module 1, which is several hundred millimeters. To ensure a largely constant direct mechanical contact C, C' between the guide element 16.2 and the guide groove 16.1, the guide groove 16.1 must meet tight tolerances. Said tolerances ensure that the guide element 16.2 does not become jammed in the guide groove 16.1. In particular, when using two guide elements 16.2 in two guide grooves 16.1 as shown in FIG. 3, there is such a risk of jamming. The tolerances are measured on the second surface 16.19, 16.19' of the groove insert 16.12, 16.12'. Preferably, the tolerances in the plane parallel to the longitudinal axis X and parallel to the vertical axis Z are less than or equal to 0.1 mm.

For the production of said tight tolerances, the groove insert 16.12, 16.12' which is inserted into the groove space 16.13 and connected via a positive fit to the groove body 16.11, 16.11' is machined to tolerance. Machining to tolerance is performed before the guide element 16.2 is inserted into the groove space 16.13. Machining to tolerance is performed in a broaching operation. Preferably, a broaching tool with at least one cutting edge is used for this purpose. The broaching tool is not shown in the figure.

The broaching tool consists of a high-strength material such as high-speed steel. The geometry of the broaching tool is such that the spatial extension of the broaching tool along the transverse axis Y is equal to the width W to be finished to tolerance between the second surfaces 16.19, 16.19' of the groove body 16.13 along the transverse axis Y. The broaching tool is drawn through the groove space 16.13 along the longitudinal axis X. In the process, the material of the groove insert 16.12, 16.12' is cut along the transverse axis Y with the cutting edge to the tolerance of the width W.

### LIST OF REFERENCE SYMBOLS

1 Joining module
11 Drive unit
12 Threaded drive
12.1 Spindle
12.2 Spindle nut
13 Plunger
14 Housing
14.1 Housing body
14.2 Cavity
15 Force transducer
16 Torque support device
16.1 Guide groove
16.11, 16.11' Groove body
16.12, 16.12' Groove insert
16.13 Groove space
16.14, 16.14' Supporting surface
16.15, 16.15' First positive-fit element
16.16, 16.16' Second positive-fit element
16.17, 16,17' Complementary positive-fit feature
16.18, 16.18' First surface
16.19, 16.19' Second surface
16.2 Guide element
16.21, 16.21' Contact surface
A - A Section path
B1 First enlarged detail
B2 second enlarged detail
C, C' Direct mechanical contact
F Force
W Width
X Longitudinal axis
XY Transverse plane
Y Transverse axis
Z Vertical axis

What is claimed is:

1. A joining module for applying a joining force to a workpiece, the joining system comprising:
a drive unit that includes, a threaded drive, which is configured to convert a rotational movement of the drive unit into a linear movement, a plunger mounted on the threaded drive and configured to be movable with the linear motion along a longitudinal axis, and a housing;
a torque support device including a guide groove mounted in the housing and defining a groove insert; and
a guide element connected to the plunger in a non-rotatable manner and disposed protruding into the guide groove in a direct mechanical contact with the groove insert, wherein the direct mechanical contact prevents rotation of the plunger about the longitudinal axis.

2. The joining module according to claim 1, wherein the guide groove defines a groove body connected to the groove insert via a positive fit.

3. The joining module according to claim 2, wherein the groove insert defines a positive-fit element; wherein the groove body defines a complementary positive-fit element configured to engage the positive-fit element in a positive-fit manner.

4. The joining module according to claim 3, wherein the groove insert is formed as a T-shaped strip that defines a first arm and a second arm, each of the first and second arms extending parallel to a transverse axis that is disposed perpendicular to the longitudinal axis;
wherein the positive-fit element defines a first positive-fit element formed on the first arm and a second positive-fit element formed on the second arm; and
wherein the complementary positive-fit element is pan-shaped and configured to receive the first positive-fit element and the second positive-fit element.

5. The joining module according to claim 2, wherein the groove body is U-shaped and defines a first leg spaced apart from a second leg such that a groove space is defined between the two legs.

6. The joining module according to claim 2, wherein the groove insert covers a covered region of the groove body.

7. The joining module according to claim 6, wherein the groove insert is formed as a T-shaped strip including a defining a first surface extending parallel to the longitudinal axis and parallel to a vertical axis, which is perpendicular to the longitudinal axis and perpendicular to the transverse axis.

8. The joining module according to claim 7, wherein the groove body defines a supporting surface with an area that extends parallel to the longitudinal axis and parallel to the vertical axis; and
wherein the first surface of the groove insert covers a covered area of the supporting surface of the groove body.

9. The joining module according to wherein the housing includes a housing body integrally formed with the groove body.

10. The joining module according to claim 9, wherein the housing body is an extruded profile made of aluminum or aluminum alloys.

11. The joining module according to claim 1, wherein the guide element defines a contact surface that lies in a plane disposed parallel to a plane defined by the longitudinal axis and a vertical axis that is perpendicular to the longitudinal axis, wherein the contact surface elongates towards the groove insert;
wherein the groove insert defines a second surface that lies in a plane disposed parallel to the plane defined by the longitudinal axis and the vertical axis, wherein the second surface elongates towards the guide element; and wherein the contact surface of the guide element forms direct mechanical contact with the second surface of the groove insert.

12. The process according to claim 11, wherein the contact surface is made of a low-wear material, which material is one of the following: anodized aluminum, hard anodized aluminum.

13. The joining module according to claim 1, wherein the groove insert is made of a material with a low coefficient of friction, which material is at least one of the following: polyoxymethylene (POM), polyethylene terephthalate (PET), polyether ether ketone (PEEK), polytetrafluoroethylene (PTFE).

14. A process for manufacturing a joining module that includes a torque support device, a drive unit, a threaded drive, a plunger, and a housing, which threaded drive converts a rotational movement of the drive unit into a linear movement, which plunger is mounted on the threaded drive and is movable with the linear motion along a longitudinal axis, which torque support device includes a guide groove and a guide element, the process comprising the following steps:
mounting the guide groove in the housing;
connecting the guide element to the plunger in a non-rotatable manner such that the guide element protrudes into certain regions of the guide groove;
moving a groove insert into the guide groove such that the guide element protruding into the guide groove is in a direct mechanical contact with the groove insert, such that the direct mechanical contact prevents rotation of the plunger about the longitudinal axis.

15. The process according to claim 14, wherein the groove insert is connected to the groove body via a positive fit.

16. The process according to claim 15, wherein the guide groove is machined to tolerance before inserting the groove insert into the guide groove.

17. The process according to claim 16, wherein the tolerance is not more than 0.1 mm.
